(19) United States
(12) Patent Application Publication
(10) Pub. No.: US 2011/0257806 A1
(43) Pub. Date: Oct. 20, 2011

(54) IED FOR, AND METHOD OF ENGINEERING, AND SA SYSTEM

(75) Inventors: Thomas Werner, Baden (CH); Jean-Charles Tournier, Bellegarde sur Valserine (FR); Stefan Richter, Fislisbach (CH)

(73) Assignee: ABB RESEARCH LTD, Zurich (CH)

(21) Appl. No.: 13/173,924

(22) Filed: Jun. 30, 2011

Related U.S. Application Data
(63) Continuation of application No. PCT/EP2009/067711, filed on Dec. 22, 2009.

(30) Foreign Application Priority Data
Jan. 7, 2009 (EP) 09150131.2

(51) Int. Cl. G06F 1/28; G06F 1/26

(52) U.S. Cl. 700/292; 700/297

(57) ABSTRACT

Intelligent Electronic Devices (IEDs) for Substation Automation (SA), such as bay units or substation PCs, are equipped with a Central Processing Unit CPU that includes a first processing core dedicated and configured to execute Protection and Control applications, and a second processing core, or network core, dedicated and configured to handle or decode network communication traffic. The network core performs computationally expensive pre-processing and/or post-processing functionality on top of the 9-2 communication stack. A plurality of network cores or a plurality of network interfaces may be provided to cope with the expected amount of IEC 61850 9-2 traffic.

### RELATED APPLICATION

This application claims priority as a continuation application under 35 U.S.C. §120 to PCT/EP 2009/067711, which was filed as an International application on Dec. 22, 2009 designating the U.S., and which claims priority to European Application 09150131.2 filed in Europe on Jan. 7, 2009. The entire contents of these applications are hereby incorporated by reference in their entireties.

### FIELD

The present disclosure relates to the field of substations, such as Substation Automation (SA) systems for substations in high and medium voltage electric power networks.

### BACKGROUND INFORMATION

Substations in high and medium-voltage power networks can include primary devices such as electrical cables, lines, bus bars, switches, power transformers and instrument transformers, which are generally arranged in switch yards and/or bays. These primary devices are operated in an automated way via a Substation Automation (SA) system. The SA system includes secondary devices, among which Intelligent Electronic Devices (IEDs) are responsible for protection, control and monitoring of the primary devices. An IED can control actuators of assigned primary devices on the basis of signals from assigned sensors for switch or tap changer position, temperature, voltage, current etc., signals from other IEDs, and signals from a supervisory system. Conversely, an IED can communicate a state or behavior of its assigned primary devices, e.g., selected sensor readings, to other IEDs or to the supervisory system.

The secondary devices can be assigned to hierarchical levels, i.e. the station level, the bay level, and the process level, the latter being separated from the bay level by a so-called process interface. IEDs on the station level of the SA system can include a supervisory computer or station PC including an Operator Work Station (OWS) with a Human-Machine Interface (HMI) and running a Supervisory Control And Data Acquisition (SCADA) software, as well as a gateway for communication with a Network Control Centre (NCC). IEDs on the bay level, also termed bay units or protection and/or control IEDs in what follows, in turn are connected to each other as well as to the IEDs on the station level via an inter-bay or station bus primarily serving the purpose of exchanging commands and status information.

Secondary devices on the process-level include sensors for voltage (VT), current (CT) and gas density measurements, contact probes for sensing switch and transformer tap changer positions, and/or actuators (I/O) for changing transformer tap positions, or for controlling switchgear like circuit breakers or disconnectors. Exemplary sensors such as non-conventional current or voltage transformers include an Analog to Digital (AD) converter for sampling of analog signals. Such sensors are connected to the bay units via a dedicated or intra-bay process bus, which can be considered as the process interface replacing the conventional hard-wired process interface. The latter connects conventional current or voltage transformers in the switchyard to the bay level equipment via dedicated copper wires, in which case the analog signals of the instrument transformers are sampled by the bay units.

A communication standard for communication between the secondary devices of a substation has been introduced by the International Electrotechnical Committee (IEC) as part of the standard IEC 61850 entitled “Communication Networks and Systems in Substations”. For non-time critical messages, IEC 61850-8-1 specifies the Manufacturing Message Specification (MMS, ISO/IEC 9506) protocol based on a reduced Open Systems Interconnection (OSI) protocol stack built upon the Transmission Control Protocol (TCP) and Internet Protocol (IP) in the transport and network layer, respectively, and upon Ethernet and/or RS-232C as physical media. For time-critical event-based messages, IEC 61850-8-1 specifies the Generic Object Oriented Substation Events (GOOSE) directly on the Ethernet link layer of the communication stack. For very fast periodically changing signals at the process level such as measured analog voltages or currents, IEC 61850-9-2 specifies the Sampled Value (SV) service, which, similar to GOOSE, builds directly on the Ethernet link layer. Hence, the standard defines a format to publish, as multicast messages on an industrial Ethernet, event-based messages and digitized measurement data from current or voltage sensors on the process level as a substitute to traditional copper wiring.

SV or other process data may be transmitted over an inter-bay process bus, making the transmitted information available to neighboring bays. For cost effective setups such as in medium or low-voltage substations, the inter-bay process bus and the station bus can be merged into one single communication network. In this case, the communication network can be considered an inter-bay process bus that transmits, in addition to the process data, command and/or status related messages otherwise exchanged via a dedicated station bus.

In other words, it is no longer necessary for a protection IED to be hardwired to respective sensors in order to receive the necessary information required for computing a specific protection function. Instead, it is possible for a protection IED to subscribe to a data stream which is available on the system-wide SA communication network or a specific sub-network thereof. The process data is digitized, optionally provided with a time-stamp, and published by a process interface, e.g., either a sensor device itself incorporating Analogto Digital (AD) converter functionality and being directly connected to the communication network, a different protection IED making its local measurements available, or a Merging Unit (MU) merging instantaneous signals of a plurality of connected sensors into a single network message. Furthermore, the possibility of separating the acquisition of measurement data and the processing of the information enables a Station PC to subscribe to the data stream, which in turn brings a couple of new architectural design options for substation automation systems, e.g. related to redundancy or backup protection concepts. For instance, within a Centralized Protection & Control scheme, PC-like devices on a station level would not only serve as a gateway or HMI console, but would also host backup functionality for the bay IED devices, or execute station-wide protection schemes such as busbar protection.

IEC 61850 9-2 traffic is a multicast protocol, allowing the client device to subscribe to specific data streams, and neglect the streams which are not relevant. However, when taking advantage of the possibility to use sensor data in arrangements such as busbar protection functions, or in Station PCs executing backup functionality for a multitude of bays, a significant amount of network traffic needs to be processed by the receiving devices. Without specific hardware support such as Field Programmable Gate Arrays (FPGAs), the amount of measurement traffic needed to be processed on the IED devices can easily exceed the available computational power of those devices, as well as the amount of interrupts generated by the network interface, and the timely processing of the packet information can easily absorb the available CPU capacity of the IED devices and therefore impact the execution of time-critical tasks.

U.S. Pat. No. 6,550,020 discloses a data processing system with at least one Integrated Circuit IC containing a central processing unit that includes at least first and second processing cores. Each of the processing cores includes a full set of the components utilized by conventional single-core CPU(s) to fetch, decode, and execute instructions and transfer information to and from other parts of the data processing system such as a global data storage or shared memory. The IC also includes input facilities that receive a control input specifying which of the processing cores is to be utilized, e.g., to utilize the second core as a virtual first processing core upon determining that the first core is inactive or defective. To this end, the IC includes configuration logic that dynamically decodes the control input and, in response, selectively controls reception of input signals and transmission of output signals of one or more core of the processing cores in accordance with the control input.

### SUMMARY

An exemplary embodiment of the present disclosure provides an Intelligent Electronic Device (IED) for Substation Automation (SA). The IED is configured to receive and process IEC 61850 9-2 network messages over a substation communication network. The IED includes a Central Processing Unit (CPU) which includes a first processing core and a network core. The network core is configured to handle IEC 61850 9-2 network traffic for the IED.

An exemplary embodiment of the present disclosure provides a method of engineering an SA system with an IED configured to receive and process IEC 61850 9-2 network messages over a substation communication network. The IED includes a CPU which includes a first processing core and a network core, where the network core is configured to handle IEC 61850 9-2 network traffic for the IED. The method includes assigning, based on at least one of a size of the SA system and an estimated amount of network traffic received by the IED, a plurality of network cores to the IED, and configuring an allocation of network messages to the plurality of network cores.

### BRIEF DESCRIPTION OF THE DRAWINGS

Additional refinements, advantages and features of the present disclosure are described in more detail below with reference to exemplary embodiments illustrated in the drawings, in which:

FIG. 1 is an IED with a CPU including two cores according to an exemplary embodiment of the present disclosure;

FIG. 2 is an IED with a CPU including two network cores according to an exemplary embodiment of the present disclosure; and

FIG. 3 is an IED with two network interfaces according to an exemplary embodiment of the present disclosure.

The reference symbols used in the drawings, and their meanings, are listed in summary form in the list of reference symbols. In principle, identical parts are provided with the same reference symbols in the drawings.

### DETAILED DESCRIPTION

Exemplary embodiments of the present disclosure provide an Intelligent Electronic Device (IED) and a method of engineering a Substation Automation (SA) system in which the data processing bottlenecks are avoided in the IEDs for the SA system.

In accordance with an exemplary embodiment of the present disclosure, IEDs for SA, such as bay units or substation PCs, are equipped with an Integrated Circuit with a Central Processing Unit (CPU) that includes a first processing core which is dedicated and configured to execute Protection and Control applications, and a second processing core, or network core, which is dedicated and configured to handle or decode network communication traffic. Hence, Protection and Control functionality in the IEDs is separated or isolated from communication issues, and the former is not impeded by the latter, e.g., in case of communication network problems. For example, the Protection and Control applications executed in the first processing core can still continue to operate, while the second processing core handling network traffic may see an interrupt flooding.

In accordance with an exemplary embodiment, the network core performs computationally expensive pre- and/or post-processing functionality in addition to the 9-2 communication stack. The latter includes receiving 9-2 packets from multiple data sources, decoding the packets, verifying the integrity of the data content and other security aspects as potentially required in the standard IEC 62351. Post-processing operations on behalf of specific protection functions, such as Digital Fourier Transformation (DFT), Root Mean Square (RMS) calculation, Digital filtering, and/or Peak-to-Peak computation, for example, generally necessitate a lot of computationally expensive floating point operations and iterative calculations.

In accordance with an exemplary embodiment, the multi-core CPU enables a scalable software architecture that is easy to maintain and to update with new functionality. For example, it allows allocating the decoding of the 9-2 network traffic to a variable number of two or more network cores depending on a few parameters, such as, for example, the number of 9-2 sources or the frequency of samples, e.g., the number of network messages received by the IED per second. Furthermore, the plurality of network cores can be assigned to one or several Network Interface Cards (NIC), the number of which represents, at least for a station PC, an additional degree of flexibility.

In accordance with an exemplary embodiment of the present disclosure, the 9-2 multicast network traffic received is distributed or re-routed to the plurality of network cores, either by the single Network Interface Card (NIC), or by a programmable switch that is part of the SA communication network and connected to two or more NICs. The allocation of the network core can be conveniently based on the Source Media Access Code (MAC) address of the individual network messages. The Source MAC address is easy to parse, e.g., it can be isolated from a received message without knowing or decoding the entire message content. In this context, it is pointed out that the security standard IEC62351 is also transparent, e.g., the entire message content including MAC of a signed message can still be read.

Since the size and extent of the SA system, including the number of sensors, the network infrastructure, and the application functionality, is already specified during engineering of the system, the instantiation of the 9-2 stack and post processing functionality required on each IED for handling the expected amount of 9-2 traffic can be done in a static fashion. Likewise, in case of more than one network core being provided, the data streams which are processed on each core can be configured or pre-allocated during engineering time. Here, a few parameters can be taken into account in order to ensure that the individual processing cores are not overloaded. As an alternative, a dynamic (re-)allocation at runtime of streams to network cores, e.g. utilizing load-balancing algorithms taking into account the computation resource requirements of various pre/post-processing tasks, can be applied as well.

As an alternative, hardware-based solutions also provide the possibility to separate and offload the processing and post-processing of network traffic. For instance, Field Programmable Gate Arrays (FPGAs) based solutions, which implement the decoding and post-processing logic in hardware and push the data through means like DMA (Direct Memory Access) to the application memory are equivalent solutions to the one proposed herein. However, adaptations, such as including, e.g., additional logic to handle security enhancements for IEC 61850, or a scaling in the number of supported sources, can require a change in hardware

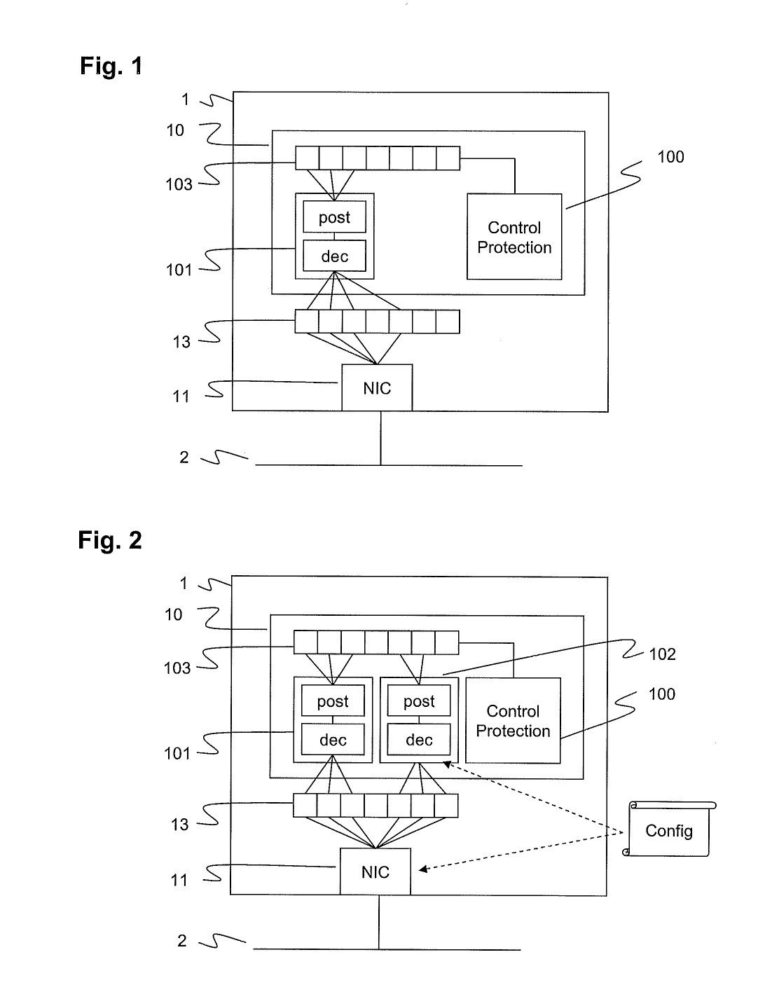

FIG. 1 shows some of the basic components of an Intelligent Electronic Device (IED) 1 for Substation Automation (SA), such as a Station PC, a bay unit, or any other embedded device with Protection and Control functionality, according to an exemplary embodiment of the present disclosure. The IED 1 has a microprocessor or Central Processing Unit (CPU) 10 with a first processing core 100 dedicated to Protection and Control tasks, and a network core 101 for handling the network traffic received via a Network Interface Card (NIC) 11. The IED 1 is connected, via the NIC 11, to an SA communication network 2, such as a process bus with IEC 61850 9-2 traffic, for example. Other IEDs of the SA system publish measurement samples as multicast messages on the network 2. The NIC 11 filters the messages according to their destination MAC address and stores the measurement data in shared input memory 13. The 9-2 decoding stack on the network core 101 reads from the shared input memory 13, processes the information, and writes the processed information to CPU core shared memory 103. Post-processing functionality running either on the network core 101 or on a different core can access the processed 9-2 message and perform additional post-processing functionality, the result of which is again stored in the CPU core shared memory 103. Protection and control functions executed on the processing core 100 can access either the decoded raw data or the additionally post-processed data from CPU core shared memory 103. In an exemplary protection mode, the IED 1 monitors the state of a substation or of a part thereof and autonomously opens an assigned circuit breaker in case it detects a potentially dangerous situation such as an overload.

Multi-core microprocessors involve a single integrated circuit that includes two or more main processing cores sharing the same Random Access Memory (RAM), each of which may be utilized as if it were a separate CPU. In accordance with an exemplary embodiment, each of the main cores provides computing power that equals or exceeds that of a conventional high-performance single core processor. In accordance with an exemplary embodiment of the present disclosure, the network core 101 is dedicated for processing 9-2 traffic (receiving, decoding, post-processing), whereas one or more cores 100 are available for the protection and control applications.

FIG. 2 depicts an IED with two network cores 101, 102 according to an exemplary embodiment of the present disclosure. In this exemplary embodiment, one network interface 11 receives all traffic, and distributes or forwards, based on configuration data resulting from the SA engineering, received packets to the network cores 101, 102 for further processing. The exact number of network cores can depend, for example, on the number of measurement samples to be processed. For example, an upper limit can be defined per core in terms of messages that it can process per second, depending, e.g., on the CPU clock speed, the post-processing functionality executed, and accounting for some safety margin. This limit then can be related to the number of sources times the sending frequency per source, giving an estimate on how many cores are required for the 9-2 processing.

Decoding is expensive as the message format is not specified in a format which would allow a simple message-copy-to-memory operation, e.g., the entire message payload has to be parsed, checked for validity, and then copied to suitable memory structures. With standard CPUs (2.0 GHz), up to 80K messages per second can be handled, for example. This may be sufficient for 20 bays of a substation. However, if post-processing is applied, then a lot of additional floating point operations are executed (basically *, div, sqrt), and most often the calculations involve some iterations (history) per message received, e.g., depending on the sampling frequency (1.6 kHz) times the system frequency (50 Hz). It is estimated that this has the potential of reducing the number of messages which can be handled per core by factor of two at least.

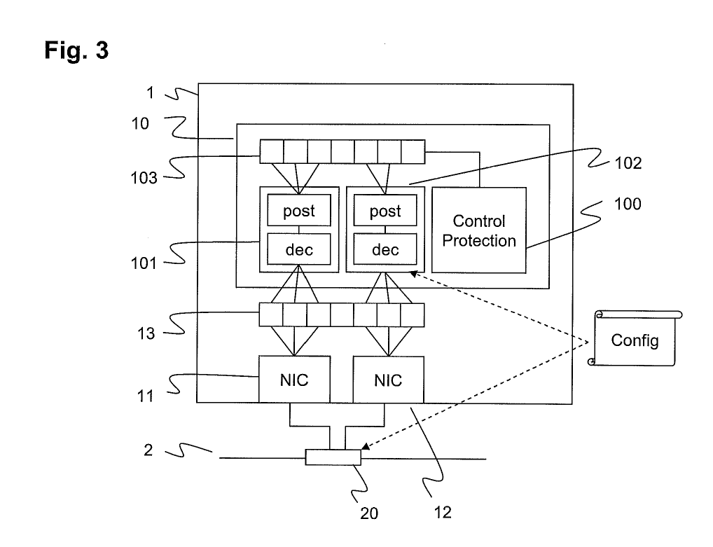

FIG. 3 shows an IED with two network cores 101, 102 and two network interfaces 11, 12, according to an exemplary embodiment of the present disclosure. In this exemplary embodiment, each of the cores has a dedicated network interface. Splitting of the network traffic is accomplished by a programmable switch 20 as a node of the SA communication network 2.

It has to be noted that the present disclosure is not limited to an SA, but extends to process automation control in general. Accordingly, any process automation control device adapted to be connected to a digital process bus and configured to receive and process network messages, where the device has a multi-core CPU and the network messages are handled by one of the cores of the multi-core CPU, may benefit from the advantages as mentioned herein.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF DESIGNATIONS

1 Intelligent Electronic Device
10 microprocessor
100 processing core
101, 102 network core
103 CPU core shared memory
11, 12 network interface
13 shared input memory
2 SA communication network
20 Switch

What is claimed is:

1. An Intelligent Electronic Device (IED) for Substation Automation (SA), wherein the IED is configured to receive and process IEC 61850 9-2 network messages over a substation communication network, the IED comprising:
a Central Processing Unit (CPU) that includes a first processing core and a network core,
wherein the network core is configured to handle IEC 61850 9-2 network traffic for the IED.

2. The IED according to claim 1, wherein the network core is configured to perform at least one of pre-processing and post-processing of the network messages.

3. The IED according to claim 1, wherein the CPU comprises a plurality of network cores configured to handle IEC 61850 9-2 network traffic.

4. The IED according to claim 3, wherein the IED is configured to allocate a network message to one of the plurality of network cores based on a source address of the network message.

5. The IED according to claim 3, comprising:
a single network interface configured to be connected to the substation communication network and to allocate a network message to one of the plurality of network cores.

6. The IED according to claim 3, comprising:
a plurality of network interfaces configured to forward a network message to a predefined one of the plurality of network cores, the plurality of network interfaces configured to be connected to a switch of the substation communication network, the switch being configured to allocate network messages to one of the network interfaces.

7. The IED according to claim 1, wherein the IED comprises a Station PC, and
wherein the first processing core is configured to execute, based on the network messages received, at least one of busbar protection functions and backup protection functionality for a multitude of bays.

8. A method of engineering an Substation Automation (SA) system with an Intelligent Electronic Device (IED) configured to receive and process IEC 61850 9-2 network messages over a substation communication network,
wherein the IED comprises a Central Processing Unit (CPU) which includes a first processing core and a network core, the network core being configured to handle IEC 61850 9-2 network traffic for the IED, and
wherein the method comprises:
assigning, based on at least one of a size of the SA system and an estimated amount of network traffic received by the IED, a plurality of network cores to the IED; and
configuring an allocation of network messages to the plurality of network cores.

9. The IED according to claim 2, wherein the CPU comprises a plurality of network cores configured to handle IEC 61850 9-2 network traffic.

10. The IED according to claim 9, wherein the IED is configured to allocate a network message to one of the plurality of network cores based on a source address of the network message.

11. The IED according to claim 9, comprising:
a single network interface configured to be connected to the substation communication network and to allocate a network message to one of the plurality of network cores.

12. The IED according to claim 9, comprising:
a plurality of network interfaces configured to forward a network message to a predefined one of the plurality of network cores, the plurality of network interfaces configured to be connected to a switch of the substation communication network, the switch being configured to allocate network messages to one of the network interfaces.

13. The IED according to claim 3, comprising:
a single network interface configured to be connected to the substation communication network and to allocate the network message to one of the plurality of network cores.

14. The IED according to claim 1, wherein the first processing core is dedicated and configured to execute Protection and Control applications of the IED in the SA system.

15. The method according to claim 8, wherein the plurality of network cores are configured to handle IEC 61850 9-2 network traffic.

16. The method according to claim 8, comprising:
allocating a network message to one of the plurality of network cores based on a source address of the network message.

17. The method according to claim 8, comprising:
allocating a network message to one of the plurality of network cores via a single network interface of the IED which is connected to the substation communication network.

18. The method according to claim 8, comprising:
allocating a network message to one of the plurality of network cores via a plurality of network interfaces, which are each configured to forward a network message to a predefined one of the plurality of network cores, the plurality of network interfaces being connected to a switch of the substation communication network, the switch being configured to allocate network messages to one of the network interfaces.

19. The method according to claim 8, comprising:
executing Protection and Control applications in the first processing core.

20. The method according to claim 8, wherein the IED comprises a Station PC, and
wherein method comprises:
executing, in the first processing core, at least one of busbar protection functions and backup protection functionality for a multitude of bays based on the network messages received.
